(19) United States
(12) Patent Application Publication
(10) Pub. No.: US 2017/0277740 A1
(43) Pub. Date: Sep. 28, 2017

(54) Commanding and Task Completion through Self-messages

(71) Applicant: Microsoft Technology Licensing, LLC, Redmond, WA (US)

(72) Inventors: Nikrouz Ghotbi, Redmond, WA (US); Paul Nathan Bennett, Redmond, WA (US)

(73) Assignee: Microsoft Technology Licensing, LLC, Redmond, WA (US)

(21) Appl. No.: 15/209,447

(22) Filed: Jul. 13, 2016

Related U.S. Application Data
(60) Provisional application No. 62/311,851, filed on Mar. 22, 2016.

(51) Int. Cl. G06F 17/30; H04L 12/58

(52) U.S. Cl. CPC G06F 17/30345; H04L 51/12; H04L 51/22; H04W 4/14

(57) ABSTRACT

Commanding and task completion through self-messages is described. In implementations, message actions may be automatically initiated and performed using self-messages that a user sends to the user's own accounts. In order to do so, a message analytics module operates to check messages associated with a user account and recognize self-messages addressed by the user to the user. The message analytics module further analyzes recognized self-messages to derive the intent of the user in sending the message. Different classifications may be associated with different message actions performable via the message analytics module and/or a digital assistant invoked by the message analytics module. Thus, based on the classification of a self-message into one or more particular categories, corresponding message actions that are specified for the particular categories are preformed to handle and manage the self-messages. In this manner, a user is able command a digital assistant and otherwise specify different tasks.

### RELATED APPLICATIONS

This Application claims priority under 35 U.S.C. §119 to U.S. Provisional Patent Application No. 62/311,851 filed Mar. 22, 2016, and titled “Commanding and Task Completion through Self Messages,” the disclosure of which is incorporated by reference in its entirety.

### BACKGROUND

A variety of kinds of computing devices have been developed to provide computing functionality to users in different settings. For example, a user may interact with a mobile phone, tablet computer, wearable device or other computing device to compose email, surf the web, edit documents, interact with applications, and access other resources. Computing devices are widely used for various forms of communication including email, instant messaging, voice-mail and so forth. In a common interaction scenario, users may send emails and other “self-messages” to themselves with reminders, to do items, notes, documents to make available on a different device, and other content. A user can then access and follow-up on the self-messages via their messaging inbox. Since existing messaging clients lack infrastructure for differentiated handling of self-messages, the self-message scenario is a user-driven process that requires user to manage self-messages on their own and initiate follow-up action manually.

### SUMMARY

Commanding and task completion through self-messages is described herein. In implementations, message actions may be automatically initiated and performed using self-messages that a user sends to one of the user's own accounts. In order to do so, a message analytics module operates to check messages associated with a user account and recognize self-messages addressed by the user to the user (e.g., sent to the same user account or another known/linked account of the user). The message analytics module further analyzes recognized self-messages to infer the intent of the user in sending the message. For instance, the message may be classified as a reminder, notes, a to-do-list item, a scheduling task, message with links or documents to store, a contact, personal information, and other classifications. Different classifications may be associated with different message actions performable via the message analytics module and/or a digital assistant invoked by the message analytics module. Thus, based on the classification of a self-message into one or more particular categories, corresponding message actions that are specified for the particular categories are preformed to handle and manage the self-message. In this manner, a user is able to use self-messages to automatically schedule tasks, save and organize content, save personal information, set reminders, command a digital assistant, and otherwise specify different commands and tasks.

Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example operating environment in accordance with one or more implementations.

FIG. 2 depicts an example implementation of a message analytics module of FIG. 1 in greater detail in accordance with one or more implementations.

FIG. 3 an example implementation of a digital assistant that utilizes a message analytics module in accordance with one or more implementations.

FIG. 4 depicts an example procedure in accordance with one or more implementations.

FIG. 5 depicts an example procedure in accordance with one or more implementations.

FIG. 6 depicts an example procedure in accordance with one or more implementations.

FIG. 7 illustrates an example system that includes an example computing device that is representative of one or more computing systems and/or devices that may implement the various techniques described herein.

### DETAILED DESCRIPTION

Overview

In a common interaction scenario, users may send emails and other “self-messages” to themselves with reminders, to do items, notes, documents to make available on a different device, and other content. A user can then access and follow-up on the self-messages via their messaging inbox. Since existing messaging clients lack infrastructure for differentiated handling of self-messages, the self-message scenario is a user-driven process that requires user to manage self-messages on their own and initiate follow-up action manually.

Commanding and task completion through self-messages is described herein. In implementations, message actions may be automatically initiated and performed using self-messages that a user sends to one of the user's own accounts. In order to do so, a message analytics module operates to check messages associated with a user account and recognize self-messages addressed by the user to the user (e.g., the same user account or another known account of the user). The message analytics module further analyzes recognized self-messages to derive the intent of the user in sending the message. For instance, the message may be classified as a reminder, notes, a to-do-list item, a scheduling task, message with links or documents to store, a contact, personal information, and other classifications. Different classifications may be associated with different message actions performable via the message analytics module and/or a digital assistant invoked by the message analytics module. Thus, based on the classification of a self-message into one or more particular categories, corresponding message actions that are specified for the particular categories are preformed to handle and manage the self-message. In this manner, a user is able to use self-messages to automatically schedule tasks, save and organize content, save personal information, set reminders, command a digital assistant, and otherwise specify different commands and tasks.

Self-message techniques described herein provide a familiar and convenient mechanism for users to complete tasks and command a digital assistant. Self-message may be in the form of email, instant messages, voice-mails and other kinds of messages. The infrastructure for automation of tasks via self-messages leverages an existing messaging interaction scenario that many users are already accustomed to using. Commanding of a digital assistant via the self-messages as described herein also mirrors the way users communicate with real-life assistants by sending messages with directives to set-up meetings, set reminders, organize documents, and so forth.

In the discussion that follows, a section titled “Operating Environment” is provided that describes an example environment suitable to employ techniques described herein. Following this, a section titled “Self-Message Examples” describes example techniques, devices, arrangements, and details in accordance with one or more implementations. Last, a section titled “Example System” describes example computing systems and devices in accordance with one or more implementations.

Operating Environment

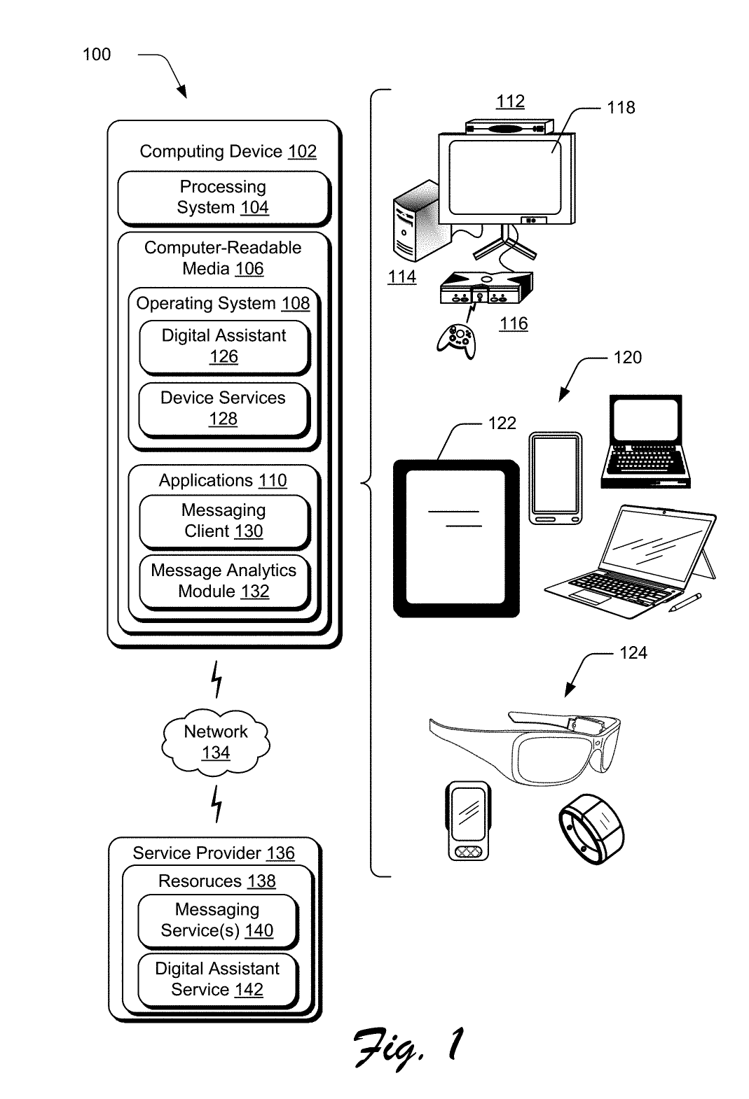

FIG. 1 illustrates an operating environment in accordance with one or more implementations, generally at 100. The environment 100 includes a computing device 102 having a processing system 104 with one or more processors and devices (e.g., CPUs, GPUs, microcontrollers, hardware elements, fixed logic devices, etc.), one or more computer-readable media 106, an operating system 108, and one or more applications 110 that reside on the computer-readable media and which are executable by the processing system. The processing system 104 may retrieve and execute computer-program instructions from applications 110 to provide a wide range of functionality to the computing device 102, including but not limited to gaming, office productivity, email, media management, printing, networking, web-browsing, and so forth. A variety of data and program files related to the applications 110 can also be included, examples of which include games files, office documents, multimedia files, emails, data files, web pages, user profile and/or preference data, and so forth.

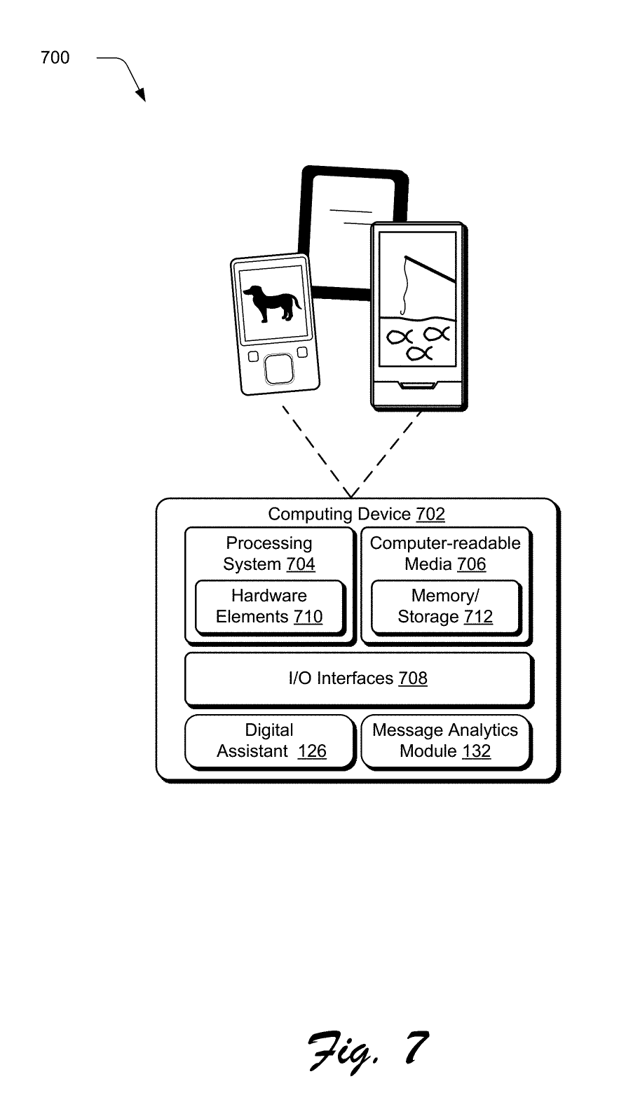

The computing device 102 can be embodied as any suitable computing system and/or device such as, by way of example and not limitation, a gaming system, a desktop computer, a portable computer, a tablet or slate computer, a handheld computer such as a personal digital assistant (PDA), a cell phone, a set-top box, a wearable device (e.g., watch, band, glasses, etc.), and the like. For example, as shown in FIG. 1 the computing device 102 can be implemented as a television client device 112, a computer 114, and/or a gaming system 116 that is connected to a display device 118 to display media content. Alternatively, the computing device may be any type of portable computer, mobile phone, or portable device 120 that includes an integrated display 122. A computing device may also be configured as a wearable device 124 that is designed to be worn by, attached to, carried by, or otherwise transported by a user. Examples of wearable devices 124 depicted in FIG. 1 include glasses, a smart band or watch, and a pod device such as clip-on fitness device, media player, or tracker. Other examples of wearable devices 124 include but are not limited to a ring, an article of clothing, a glove, and a bracelet, to name a few examples. Any of the computing devices can be implemented with various components, such as one or more processors and memory devices, as well as with any combination of differing components. One example of a computing system that can represent various systems and/or devices including the computing device 102 is shown and described below in relation to FIG. 7.

The computer-readable media can include, by way of example and not limitation, all forms of volatile and non-volatile memory and/or storage media that are typically associated with a computing device. Such media can include ROM, RAM, flash memory, hard disk, removable media and the like. Computer-readable media can include both “computer-readable storage media” and “communication media,” examples of which can be found in the discussion of the example computing system of FIG. 7.

The computing device 102 may include or make use of a digital assistant 126. In the illustrated example, the digital assistant 126 is depicted as being integrated with the operating system 108. The digital assistant 126 may alternatively be implemented as a stand-alone application, or a component of a different application such as a browser or messaging client application. The digital assistant 126 represents functionality operable to perform requested tasks, provide requested advice and information, and/or invoke various device services 128 to complete requested actions. The digital assistant may utilize natural language processing, a knowledge database, and artificial intelligence implemented by the system to interpret and respond to requests in various forms.

For example, requests may include spoken or written (e.g., typed text) data that is interpreted through natural language processing capabilities of the digital assistant. The digital assistant may interpret various input and contextual clues to infer the user's intent, translate the inferred intent into actionable tasks and parameters, and then execute operations and deploy device services 128 to perform the tasks. Thus, the digital assistant 126 is designed to act on behalf of a user to produce outputs that fulfill the user's intent as expressed during natural language interactions between the user and the digital assistant. The digital assistant 126 may be implemented using a client-server model with at least some aspects being provide via a digital assistant service component as discussed below.

In accordance with techniques described herein, the digital assistant 126 includes or makes use of functionality for processing and handling of self-messages to infer corresponding user intent and take appropriate actions for task completion, device operations, and so forth in response to the self-messages. Functionality for processing and handling of self-messages may be implemented in connection with a messaging client 130 and a message analytics module 132.

The messaging client 130 represents functionality to enable various kinds of communications over a network including but not limited to email, instant messaging, voice communications, text messaging, chats, and so forth. The messaging client 130 may represent multiple separate desktop or device applications employed for different types of communications. The messaging client 130 may also represent functionality of a browser or other suitable application to access web-based messaging accounts via available from a service provider over a network.

The message analytics module 132 represents functionality to implement techniques for commanding and task completion through self-messages as described above and below. Message analytics module 132 may be implemented as a stand-alone application as illustrated. In this case, the digital assistant 126, messaging client 130, and other applications 110 may invoke the message analytics module 132 to perform operations for analysis of messages. Alternatively, the message analytics module 132 may be implemented as an integrated component of the operating system 108, digital assistant 126, messaging client 130, or other application/service. Generally, the message analytics module 132 is operable to check messages associated with a user account and recognize self-messages addressed by the user to the user (e.g., the same user account or another known account of the user). The message analytics module 132 further analyzes content of recognized self-messages to derive the intent of the user in sending the message. The message analytics module 132 associates tags with messages indicative of categories into which the messages are classified. The message analytics module 132 may cause performance of message actions based on classification of messages in various ways. Functionality to trigger message actions may be included as part of the message analytics module 132. In addition or alternatively, the message analytics module 132 may be configured to invoke and interact with the digital assistant 126 to initiate performance of message actions through functionality implemented by the digital assistant 126.

The environment 100 further depicts that the computing device 102 may be communicatively coupled via a network 134 to a service provider 136, which enables the computing device 102 to access and interact with various resources 138 made available by the service provider 136. The resources 138 can include any suitable combination of content and/or services typically made available over a network by one or more service providers. For instance, content can include various combinations of text, video, ads, audio, multi-media streams, animations, images, webpages, and the like. Some examples of services include, but are not limited to, an online computing service (e.g., “cloud” computing), an authentication service, web-based applications, a file storage and collaboration service, a search service, messaging services 140 such as email, text and/or instant messaging, and a social networking service.

Services may also include a digital assistant service 142. Here, the digital assistant service 142 represents server-side components of a digital assistant system that operates in conjunction with client-side components represented by the digital assistant 126. The digital assistant service 142 enables digital assistant clients to plug-in to various resources 138 such as search services, analytics, community-based knowledge, and so forth. The digital assistant service 142 can also populate updates across digital assistant client applications, such as to update natural language processing and keep a knowledge database up-to-date.

Having described an example operating environment, consider now example details and techniques associated with one or more implementations.

Self-Message Examples

This section describes example techniques, devices, arrangements, and details related to using self-messages for commanding and task completion in accordance with one or more implementations.

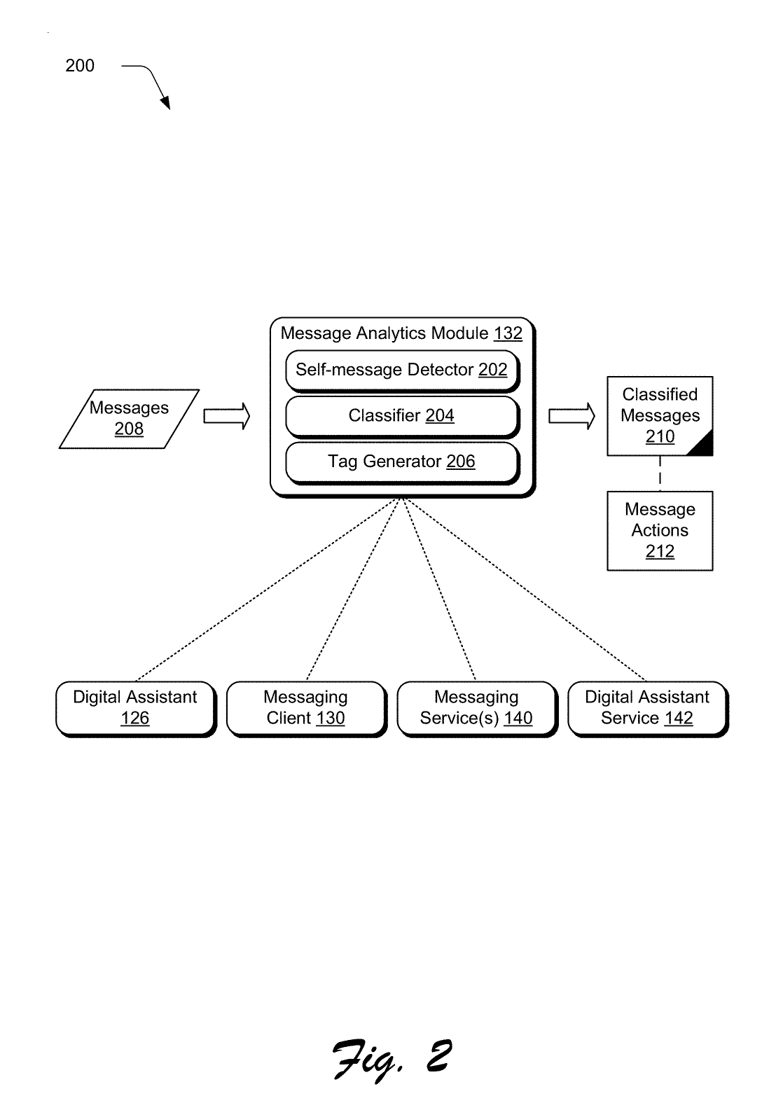

FIG. 2 depicts generally at 200 an example implementation of message analytics module 132 of FIG. 1 in greater detail. The message analytics module 132 may be implemented as a component of various applications example of which include the digital assistant 126, messaging client 130, messaging service 140, or digital assistant service 142 as represented in FIG. 2. Message analytics module 132 may also be implemented as a stand-alone application as represented in FIG. 1. As noted, the message analytics module 132 is generally operable to check messages associated with a user account and recognize self-messages addressed by the user to the user. For example, a message that is addressed to the same user account employed to send the message and messages addressed to other known account associated with the same user are recognize as self-messages. In this context, the message analytics module 132 may include a self-message detector 202, a classifier 204, and a tag generator 206.

The self-message detector 202 performs processing to check messages 208 and identify those messages that are considered self-messages. The self-messages are generally messages that are addressed to a user's own account (e.g., the user's own contact information). Accordingly, the self-message detector 202 examines message addressing fields to find addressees that match the user preparing and/or sending the message. The self-message detector 202 may also examine the message structure, attachments, and content (e.g., subject and body) to obtain additional cues indicative of self-messages. For example, a message having an attachment with just one addressee and no subject or body may likely be a message a user is sending to his or her self. Likewise, the self-message detector 202 can look for links, bulleted lists, and other types of message structures associated with a high probability of being self-messages.

In an implementation, the self-message detector 202 is designed to perform analysis upon messages that are sent by the user. The sent messages may be processed individually as the messages are “sent” by the user by selection of send option or otherwise (e.g., as the messages are placed or released to an outbox of the messaging client and are being processed for sending). In another example, the self-message detector 202 may periodically examine messages in a user's sent message folder in batches to recognizes any self-messages. Scoping the processing down to sent messages reduces processing and time involved in the detection process.

Naturally, the self-message detector 202 may also be applied for detection beyond just sent messages in some scenarios. For example, the self-message detector 202 may be configured to process messages as the messages are be drafted. In this case, the system may provide suggestions or prompts regarding self-messages that can notify a user regarding self-message options and guide a user to select or otherwise add particular commands or language to trigger particular actions. In another example, self-message detector 202 may operate upon the user's inbox and/or particular selected folders, periodically or on-demand in response to a user selection to perform self-message detection.

In various scenarios, messages may be processed and self-messages detected prior to the messages actually being sent. For instance, messages are processed prior to being sent both when messages are processed when placed in an outbox and when messages are processed as the messages are be drafted. In such scenarios, the system may be configured to avoid actually sending messages recognized as self-messages and instead just initiate the actions/commands associated with the messages. Selectively holding back messages from being sent in this manner recognizes the primary intent of the self-message as being to cause some specified or underlying action rather than communication of the message itself. The system may be set-up to automatically hold back self-messages or may do so in accordance with a selectable options or setting that may be used to toggle message hold-back on/off. By not sending selected messages in this way, communication traffic is decreased, use of processing resources is reduced on both the client and server side, and the system is able to trigger actions associated with self-messages quickly and efficiently since unnecessary communications/round-trips for sending a self-message are avoided.

Once self-messages are identified, the classifier 204 operates to perform further processing to classify the messages. In particular, the classifier 204 represents functionality to analyze the self-messages to infer intent of the user. In other words, the classifier 204 attempts to determine what the user was trying to do by sending the message to the user's own account. To do so, the classifier 204 parses message content, attachments, and metadata to detect the intent of the message. This may include processing of both the message subject and the body. This analysis may include natural language processing to understand the intent, and extract words as commands and tags indicated by the message content.

The classifier 204 then classifies the messages into different categories according to the intent of the user. Examples of different categories of messages that can be mapped to user intent include but are not limited to reminders; to-do-lists; personal information such as passwords, membership numbers, credit card information; documents to save; lists such as shopping lists; appointments; contact information; maps and locations; and reading list items to name a few examples. This list of can categories can also be established on a per user level and/or may grow and change based on continued machine learning and updates to the digital assistant system. The classifier 204 can also associate the message with a confidence value, level, or percentage indicative of how confident the system is in the particular classification.

Tag generator 206 represents functionality to create and assign tags indicative of the message classifications and message content to messages. The tag generator 206 updates metadata associated with messages 208 to produce classified messages 210. Tags associated with the classified messages 210 indicate the category or categories assigned to the messages. The tags may also include extracted data fields such as relevant dates, locations, names, links, commands, action words, and so forth. The extracted data fields facilitate automatic assignment of task/actions to classified messages 210 and completion of the task/actions. The tags also enable resurfacing of messages based on context at appropriate times, such as exposing a hotel reservation for a trip when as user arrives at the hotel, or giving an option to input a password derived from a self-message when a user initiates access to a corresponding account.

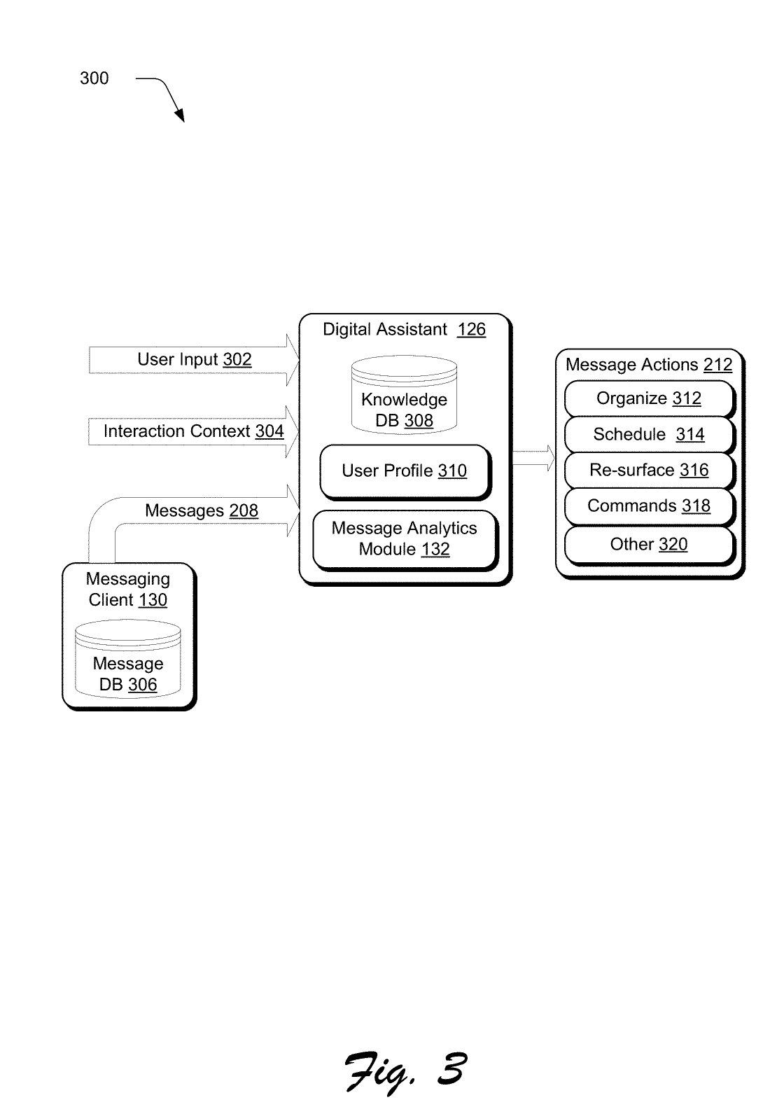

In particular, different classifications may be associated with different message actions 212 performable via the message analytics module 132 and/or a digital assistant 126 invoked by the message analytics module. Thus, classified messages 210 are represented as being assigned different message actions 212 that are associated with different classifications. A variety of message actions 212 are contemplated, details of which are described below in relation to the discussion of FIG. 3 that follows.

In this context, FIG. 3 is a diagram that depicts generally at 300 an example implementation of a digital assistant that utilizes a message analytics module in accordance with one or more implementations. For example, a digital assistant 126 may be designed to implement processing and handling of self-messages to infer corresponding user intent and take appropriate actions for task completion, device operations, and so forth in response to the self-messages. In one or more implementations, the digital assistant 126 includes or makes use of a message analytics module 132 as described throughout this document.

To process messages 208, as well as other requests, the digital assistant 126 may rely upon user input 302 as well as information regarding the current interaction context 304. Messages 208 for self-message detection may be accessed from or otherwise obtained via a message database 306 available via a messaging client. The message database 306 may represent a local message repository stored on a computing device 102 or a cloud-based database accessible via a service provider 136. Consequently, processing of messages as described herein can occur on the device-side when messages are synced to the messaging client 130 and/or on the server-side for web accessible message databases. Message processing may be scoped down to sent items as noted previous and/or include other messages such as incoming messages, particular folders, and so forth.

The digital assistant 126 may further rely upon a knowledge database 308 and user profile 310. The knowledge database 308 represents a dynamic repository of information that may be employed for searches, to find answers to questions, to facilitate natural language processing, and otherwise enable features of the digital assistant 126. Knowledge database 308 can be referenced during classification of messages to determine actions to take for different classes of messages. The user profile 310 represents the user's particular settings, preferences, behaviors, interests, contacts, and so forth. The user profile 310 may include settings and preferences for handling of self-messages in accordance with the techniques discussed herein.

In operation, the digital assistant 126 obtains messages 208 and processes the messages via the message analytics module 132 in the manner discussed previously. Processing performed by the message analytics module 132 to detect self-messages and classify the messages may be informed by the user input 302, interaction context 304, knowledge database 308, and user profile 310.

The self-messages are tagged in accordance with the classifications to generate classified messages 210 as discussed in relation to FIG. 2. The digital assistant 126 through the message analytics module 132 further operates to assign message actions 212 to the classified messages 210. The message actions 212 are designed to implement tasks and commands to carry the inferred user intent of the self-messages. For example, if a message is classified as indicating an appointment, the digital assistant 126 assigns and carries out a message action to schedule the appointment on behalf of the user. Likewise, if a message is classified as requesting a reminder, a message action to carry out the reminder is set.

FIG. 3 represents some illustrative example types of message actions 212 that may be performed responsive to detection of self-messages and classification of the messages. For instance, message actions 212 may include actions to organize 312 content obtained via self-messages such as by storing attachments, filtering messages, creating lists, moving items to folders, creating contacts, grouping self-messages, and so forth. Message actions 212 may also include actions for scheduling 314 such as creating appointments, adding items to to-do lists, tracking items, and setting reminders. Message actions 212 may additionally include tasks to re-surface messages or content from message based on context. For example, flight information may be exposed on the day of a flight and/or when it is time to check-in. A stored loyalty number for a car rental company may be re-surfaced when the system detects that a user is booking a car online. An option to load a document attached to a self-email may be present based on context that indicates an appropriate circumstance, such as exposing a slideshow document close to a time a user is scheduled to give a corresponding presentation. In another example, if a user signs up for a new website sends a text message containing the password and login as a self-message, the digital assistant can surface the text message or content of the message automatically the next time the user attempts to access the website. This automatic reengagement through resurfacing assist users in managing information they intend to capture using self-messages and relieves the users of having to manually keep track of and search on their own for self-messages. Consequently, users are less likely to lose track of emails and other messages sent to self.

Message actions 212 further include commands 318 that may correspond to pre-established keywords and ways in which a user is able to command the digital assistant 126 to perform particular actions via self-messages. For example, the self-message may specify a command like “store this document online” or “add this link to my favorites.” In these example, the keywords “store this document” and “add this link” are configured as pre-established commands tied to particular command actions. In this case, the user is able to direct specific actions by the digital assistant explicitly using the commands 318 instead of relying on the system to infer intent.

Commands 318 may be employed among other things to transfer documents between devices, pre-populate messages, set-up meetings, store items in memory, create reading lists, and other tasks that the digital assistant can automate and handle on behalf of a user in response to a self-message. Accordingly, the digital assistant operates to start and completes the tasks that are sent by self-messages, and in particular task specified using explicit commands. For example, if a user sends a self-message saying “set up time with Marcus to review the FY17 number”, the digital assistant can set the meeting up and/or offer a one click option to set-up the meeting after finding available times. Likewise, if the user sends a self-message saying “send email to Marcus about the FY17 expense report,” the digital assistant interprets this as a command to prepare the draft email and attach the appropriate document so that the user can just review, add some text if necessary, and tap send when the draft is surfaced to the user.

Various other 320 types of message actions 212 are also contemplated such as conducting searches, making suggestions, answering questions, prepping and sending messages, and additional actions available via the digital assistant 126.

Example Procedures

To further illustrate, consider the discussion in this section of example procedures and implementation details related to self-messages. The procedures described in this document may be implemented utilizing the environment, system, devices, and components described herein and in connection with any suitable hardware, software, firmware, or combination thereof. The procedures may be represented as a set of blocks that specify operations performed by one or more entities and are not necessarily limited to the orders shown for performing the operations by the respective blocks.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

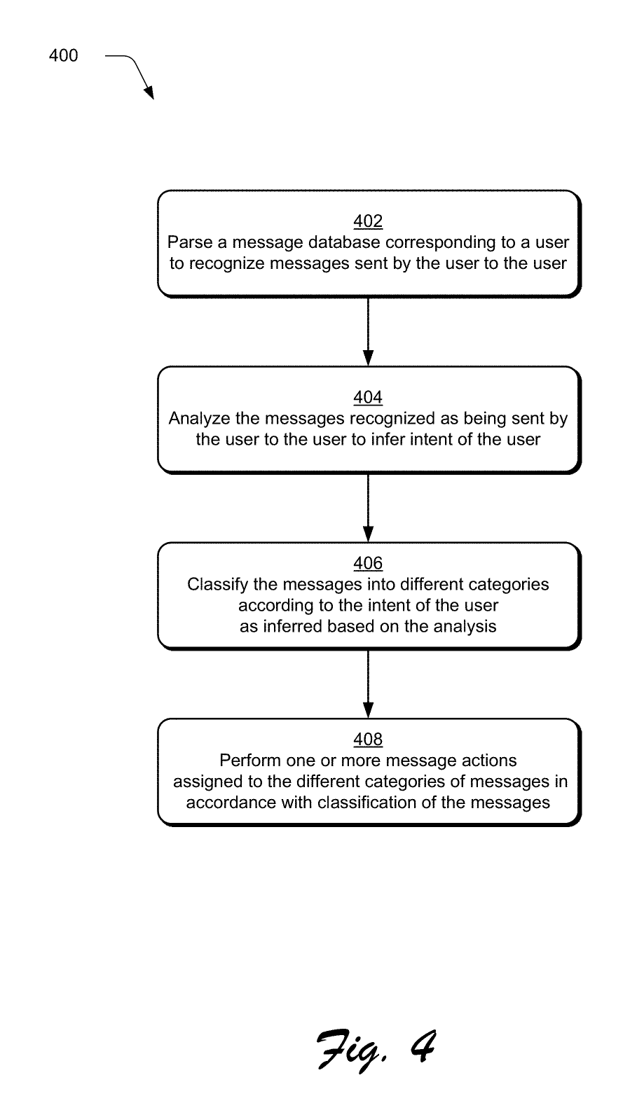

FIG. 4 depicts an example procedure 400 for processing self-messages in accordance with one or more implementations. A message database corresponding to a user is parsed to recognize messages sent by the user to the user (block 402). The messages recognized as being sent by the user to the user are analyzed to infer intent of the user (block 404). For example, messages corresponding to an account of the user may be accessible via a message database 306. Messages may include one or more of email messages, text messages, instant messages, and voicemail messages created using corresponding messaging client 130 applications. A messaging analytics module 132 as described herein may be employed to detect messages that are self-messages based on processing of message content and the structure of messages. This may include examining message addressing fields to find addressees that match the user preparing and/or sending the message. Matching addresses may include identifying addresses that are the same as well as different known accounts for the same user. In some implementations, the messaging analytics module 132 is provided as a component of a digital assistant 126. The messaging analytics module 132 and/or the digital assistant 126 may operate individually or in combination to perform processing of the message and content to infer the user intent related to the message.

The messages are classified into different categories according to the intent of the user as inferred based on the analysis (block 406). For example, the messaging analytics module 132 and/or the digital assistant 126 may operate individually or in combination to classify messages as described herein. As noted different categories into which messages are classified include but are not limited to one or more of reminders, to-do-lists; personal information such as passwords, membership numbers, credit card information; documents to save; lists such as shopping lists; appointments; contact information; maps and locations; and reading list items.

One or more message actions that are assigned to the different categories of messages in accordance with classification of the messages are performed (block 408). Various message actions 212 may be assigned to or otherwise associated with self-messages based on the categorization. As noted, different message actions 212 assigned to self-messages may include but are not limited to one or more of actions to organize content, schedule tasks, resurface messages or content, and/or command a digital assistant

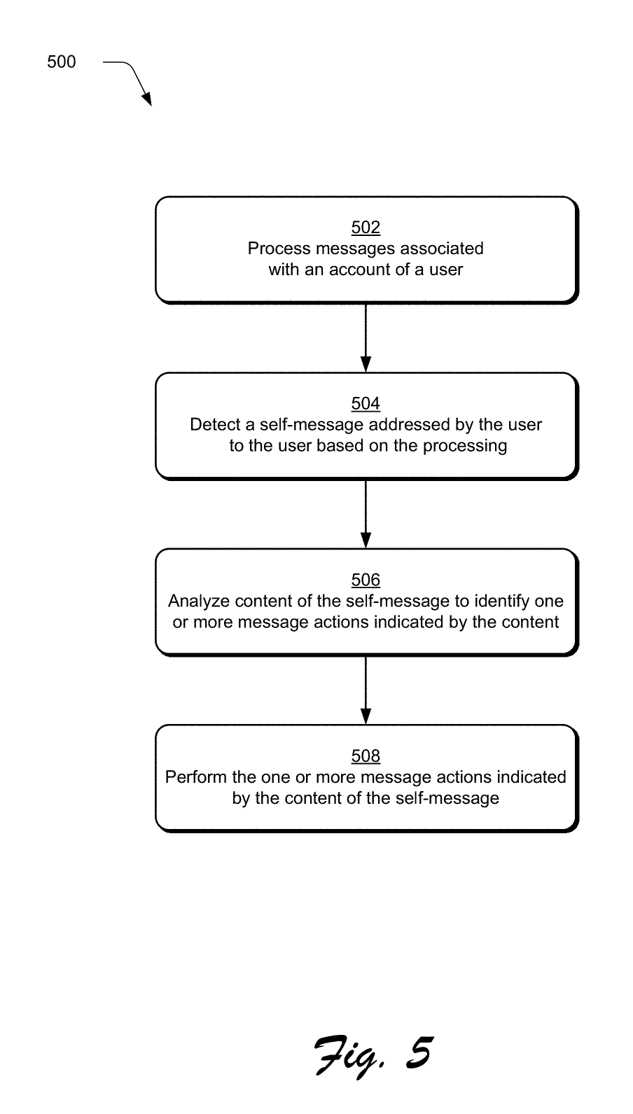

FIG. 5 depicts an example procedure 500 for detecting and handling a self-message in accordance with one or more implementations. Procedure 500 may be implemented in the context of various components, examples, and details regarding self-messages and processing/handling of self-messages as discussed throughout this document. Messages associated with an account of a user are processed to detect a self-message addressed by the user to the user based on the processing (block 502). A self-message addressed by the user to the user is detected based on the processing (block 504). Content of the self-message is analyzed to identify one or more message actions indicated by the content (block 506). Then, the one or more message actions indicated by the content of the self-message are performed (block 508).

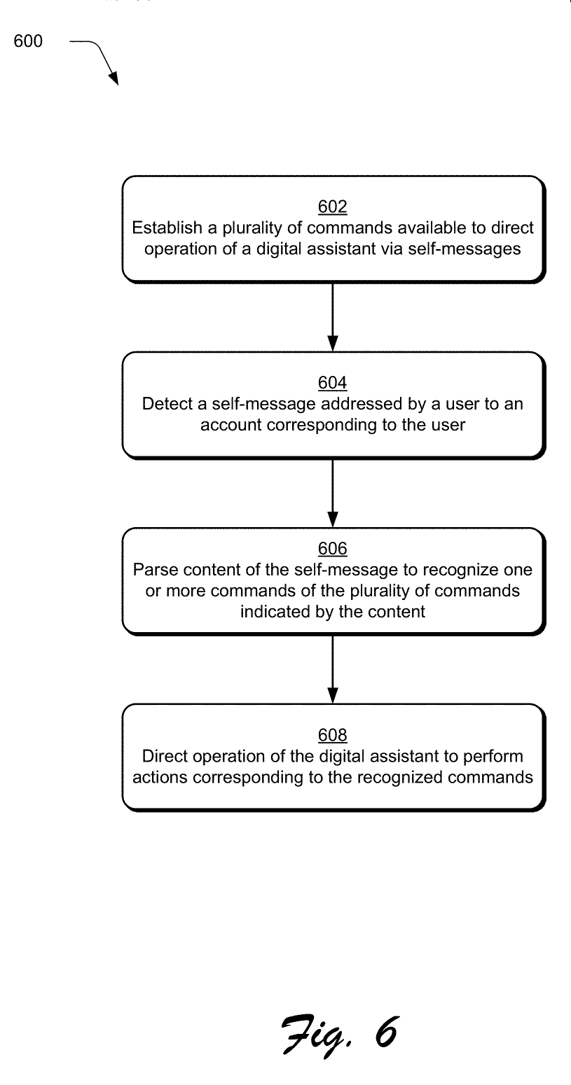

FIG. 6 depicts an example procedure 600 in accordance with one or more implementations. Procedure 600 may be implemented in the context of various components, examples, and details regarding self-messages and processing/handling of self-messages as discussed throughout this document. A plurality of commands available to direct operation of a digital assistant via self-messages are established (block 602). A self-message addressed by a user to an account corresponding to the user is detected (block 604). Content of the self-message is parsed to recognize one or more commands of the plurality of commands indicated by the content (block 606). Then, operation of the digital assistant is directed to perform actions corresponding to the recognized commands (block 606).

Having considered the foregoing example details and procedures, consider a discussion of an example system in accordance with one or more implementations.

Example System and Device

FIG. 7 illustrates an example system generally at 700 that includes an example computing device 702 that is representative of one or more computing systems and/or devices that may implement the various techniques described herein. For example, the computing device 702 include a digital assistant 126 and/or message analytics module 132 as described previously.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” refers to media and/or devices that enable persistent storage of information in contrast to mere signal transmission, carrier waves, or signals per se. Thus, computer-readable storage media does not include transitory media or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

### EXAMPLE IMPLEMENTATIONS

Example implementations of techniques described herein include, but are not limited to, one or any combinations of one or more of the following examples:

### Example 1

A method comprising: parsing a message database corresponding to a user to recognize messages as self-message sent by the user to the user's own messaging account; analyzing the messages recognized as being sent by the user to the user's own messaging account to infer intent of the user; classifying the messages into different categories according to the intent of the user as inferred based on the analysis; and performing one or more message actions assigned to the different categories of messages in accordance with classification of the messages.

### Example 2

A method as described in any one or more examples in this section, wherein the parsing comprises parsing messages sent via an account corresponding to the user.

### Example 3

A method as described in any one or more examples in this section, wherein the parsing comprises examining address fields of the messages to find messages addressed to known accounts of the user.

### Example 4

A method as described in any one or more examples in this section, wherein the parsing comprises identifying messages addressed to an account that matches an account used to prepare the messages.

### Example 5

A method as described in any one or more examples in this section, wherein the messages comprise email messages formed via an email application.

### Example 6

A method as described in any one or more examples in this section, wherein the messages comprise text messages formed via a text messaging application.

### Example 7

A method as described in any one or more examples in this section, wherein analyzing the messages to infer intent of the user comprise invoking a digital assistant.

### Example 8

A method as described in any one or more examples in this section, wherein different categories into which messages are classified include at least one of: reminders, to-do-lists; personal information; documents to save; lists; appointments; contact information; maps and locations; or reading list items.

### Example 9

A method as described in any one or more examples in this section, wherein message actions assigned to different categories include one or more of actions to organize content, schedule tasks, resurface messages or content, or command a digital assistant.

### Example 10

A method as described in any one or more examples in this section, wherein performing one or more message actions comprises directing operation of a digital assistant based on one or more commands extracted from at least one of the messages recognized as being sent by the user to the user.

### Example 11

A method implemented by a computing device comprising: processing messages associated with an account of a user including examining address fields of the messages and identifying the self-message as being addressed to a known account of the user; detecting a self-message addressed by the user to the user based on the processing; analyzing content of the self-message to identify one or more message actions indicated by the content; and performing the one or more message actions indicated by the content of the self-message.

### Example 12

A method as described in any one or more examples in this section, wherein the method is implemented by a digital assistant executed by the computing device.

### Example 13

A method as described in any one or more examples in this section, wherein messages identified as self-messages include messages sent from an account that is the same account to which the message is addressed.

### Example 14

A method as described in any one or more examples in this section, wherein the processing further comprises examining messages in a user's sent message folder to recognize self-messages.

### Example 15

A method as described in any one or more examples in this section, wherein the processing further comprises examining messages as the messages are being drafted.

### Example 16

A method as described in any one or more examples in this section, wherein the processing further comprises examining messages that are placed in an outbox prior to the messages being sent.

### Example 17

A method as described in any one or more examples in this section, wherein the processing further comprises examining message structure, attachments, and content to obtain additional cues indicative of self-messages.

### Example 18

A computing device comprising: a processing system; and computer-readable media storing instructions that, when executed by the processing system, cause the computing device to implement one or more modules configured to perform operation comprising: establishing a plurality of commands available to direct operation of a digital assistant via self-messages; detecting a self-message addressed by a user to an account corresponding to the user; parsing content of the self-message to recognize one or more commands of the plurality of commands indicated by the content; and directing operation of the digital assistant to perform actions corresponding to the recognized commands.

### Example 19

A computing device as described in claim 19, wherein the self-message comprises an email message formed via an email messaging application.

### Example 20

A computing device as described in claim 19, wherein directing operation of the digital assistant to perform actions comprises re-surfacing content associated with the self-message based on a detected context.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A method comprising:
parsing a message database corresponding to a user to recognize messages as self-messages sent by the user to the user's own messaging account;
analyzing the messages recognized as being sent by the user to the user's own messaging account to infer intent of the user;
classifying the messages into different categories according to the intent of the user as inferred based on the analysis; and
performing one or more message actions assigned to the different categories of messages in accordance with classification of the messages.

2. A method as described in claim 1, wherein the parsing comprises parsing messages sent via an account corresponding to the user.

3. A method as described in claim 1, wherein the parsing comprises examining address fields of the messages to find messages addressed to known accounts of the user.

4. A method as described in claim 1, wherein the parsing comprises identifying messages addressed to an account that matches an account used to prepare the messages.

5. A method as described in claim 1, wherein the messages comprise email messages formed via an email application.

6. A method as described in claim 1, wherein the messages comprise text messages formed via a text messaging application.

7. A method as described in claim 1, wherein analyzing the messages to infer intent of the user comprise invoking a digital assistant to process the message using one or more of natural language processing, a knowledge database, or artificial intelligence.

8. A method as described in claim 1, wherein different categories into which messages are classified include at least one of: reminders, to-do-lists; personal information; documents to save; lists; appointments; contact information; maps and locations; or reading list items.

9. A method as described in claim 1, wherein message actions assigned to different categories include one or more of actions to organize content, schedule tasks, resurface messages or content, or command a digital assistant.

10. A method as described in claim 1, wherein performing one or more message actions comprises directing operation of a digital assistant based on one or more commands extracted from at least one of the messages recognized as being sent by the user to the user.

11. A method implemented by a computing device comprising:
processing messages associated with an account of a user including examining address fields of the messages and identifying the self-message as being addressed to a known account of the user;
detecting a self-message addressed by the user to the user based on the processing;
analyzing content of the self-message to identify one or more message actions indicated by the content; and
performing the one or more message actions indicated by the content of the self-message.

12. A method as described in claim 11, wherein the method is implemented by a digital assistant executed by the computing device.

13. A method as described in claim 11, wherein messages identified as self-messages include messages sent from an account that is the same account to which the message is addressed.

14. A method as described in claim 11, wherein the processing further comprises examining messages in a user's sent message folder to recognize self-messages.

15. A method as described in claim 11, wherein the processing further comprises examining messages as the messages are being drafted.

16. A method as described in claim 11, wherein the processing further comprises examining messages that are placed in an outbox prior to the messages being sent.

17. A method as described in claim 11, wherein the processing further comprises examining message structure, attachments, and content to obtain additional cues indicative of self-messages.

18. A computing device comprising:
a processing system; and
computer-readable media storing instructions that, when executed by the processing system, cause the computing device to implement one or more modules configured to perform operation comprising:
establishing a plurality of commands available to direct operation of a digital assistant via self-messages;
detecting a self-message addressed by a user to an account corresponding to the user;
parsing content of the self-message to recognize one or more commands of the plurality of commands indicated by the content; and
directing operation of the digital assistant to perform actions corresponding to the recognized commands.

19. A computing device as described in claim 19, wherein the self-message comprises an email message formed via an email messaging application.

20. A computing device as described in claim 19, wherein directing operation of the digital assistant to perform actions comprises re-surfacing content associated with the self-message based on a detected context.
